(19) United States
(12) Patent Application Publication
(10) Pub. No.: US 2005/0050642 A1
(43) Pub. Date: Mar. 10, 2005

(54) Chain detaching handle tool

(76) Inventor: Chun Te Lee, Chang Hua Hsein (TW)

Correspondence Address: CHUN TE LEE, 235 Chung-Ho, Box 8-24, Taipei, TW

(21) Appl. No.: 10/929,138

(22) Filed: Aug. 30, 2004

(30) Foreign Application Priority Data
Sep. 5, 2003 (TW) 092216071

(51) Int. Cl. B25B 7/22; B25B 13/00

(52) U.S. Cl. 7/138

(57) ABSTRACT

A chain detaching handle tool comprises a body; a center of one side of the body having a notch; first protrusion being formed at an upper portion of the body and a second protrusion being formed at a lower portion of the body; a center of the first protrusion having a screw hole; a push element with a post being received in the screw hole; and the second protrusion having a slot; an extension portion at one side of the body opposite to the notch; a plurality of penetrating holes being formed in the extension portion; each of the penetrating holes being passed by a rod unit; each rod unit having an L shape; and one side of each rod unit having a driving portion for driving an object.

### FIELD OF THE INVENTION

The present invention relates to handle tools, and particular to a chain detaching which can be carried easily. Moreover, the handle tool can be operated easily with less power.

### BACKGROUND OF THE INVENTION

In one prior art, a bicycle chain detaching device is disclosed. The device is formed by a body, a support plate, a handle, a rotary push rod, a rotary bar, an ejecting unit, a resisting screw, etc. One side of the body of the device has a recess. Each of two sides of the recess has a respective threaded hole. The rotary push rod is assembled to one threaded hole. A distal end of the rod has the rotary bar. An end portion of the rotary push rod is assembled with the ejecting unit. A front end of the ejecting unit has a tapered shape. Another threaded hole of the body is assembled with a resisting screw. The screw has a hole. The notch of the body has the support plate. By above mentioned design, a chain is supported on a supporting edge of the support plate. Then the rotary push rod is rotated so that the ejecting unit moves toward a connecting pin of the chain to apply a pressure thereto until the connecting pin retracts from a pivotal portion of the chain. Thereby, the chain can be updated or repaired.

Although the prior art device has the effect of update or repair, the prior art has only the function of detaching the chain. When the user desires to release or lock the screw from the chain, the user must find a spanner. Thereby, the operation is inconvenient and the user must add an extra tool set. This is uneconomical. Thereby, if the user must prepare a chain detaching device and a spanner, this is very inconvenient to the user. Thus, the user will feel unhappy in the travel.

Besides, the rotary push rod of the prior art has a rotary bar at one end. Generally, the rotary bar passes through one end of the rotary push rod for driving the rotary push rod. The rotary bar is vertical to the rotary push rod. Not only a larger space is necessary, but also it is unbeneficial to store the device. Thereby, the prior art is necessary to be improved.

### SUMMARY OF THE INVENTION

Accordingly, the primary object of the present invention is to provide a chain detaching handle tool which can be carried easily.

Another object of the present invention is to provide a chain detaching handle tool, wherein the handle tool can be operated easily with less power.

To achieve above object, the present invention provides chain detaching handle tool which comprises a body; a center of one side of the body having a notch; first protrusion being formed at an upper portion of the body and a second protrusion being formed at a lower portion of the body; a center of the first protrusion having a screw hole; a push element with a post being received in the screw hole; and the second protrusion having a slot; an extension portion at one side of the body opposite to the notch; a plurality of penetrating holes being formed in the extension portion; each of the penetrating holes being passed by a rod unit; each rod unit having an L shape; one side of each rod unit having a driving portion for driving an object. The driving portion each rod unit has a polygonal shape or a cruciform shape or the driving portion each rod unit has a straight shape.

The second protrusion has a screw hole for installing a resisting element. The extension portion of the body has a plurality of slots. A third protrusion is protruded from the body and below the second protrusion; and the resisting element is rotated downward so as to be used as an adjustable spanner.

The chain detaching handle tool further comprises a tool set. The tool set comprises two sheets installed oppositely; two pivotal shafts installed at two sides of the two sheets; a plurality of tools installed to the pivotal shaft; the tools being rotatable along the pivotal shaft. The tools are capable of being assembled to the body. A selected one of the tools is inserted into the penetrating hole in the extension portion of the body. The two sheets are formed integrally as a U shape body.

The various objects and advantages of the present invention will be more readily understood from the following detailed description when read in conjunction with the appended drawing.

### BRIEF DESCRIPTION OF THE DRAWINGS

FIG. 1 is an exploded perspective view of the first embodiment of the present invention.

FIG. 2 is an assembled schematic view of the first embodiment of the present invention.

FIG. 3 is a schematic view showing the operation of detaching a chain according to the first embodiment of the present invention.

FIG. 4 is an assembled schematic view of the second embodiment of the present invention.

FIG. 5 is an assembled schematic view of the third embodiment of the present invention.

FIG. 6 is an assembled schematic view of the fourth embodiment of the present invention.

FIG. 7 is an assembled schematic view of the fifth embodiment of the present invention.

FIG. 8 is an assembled schematic view of the sixth embodiment of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

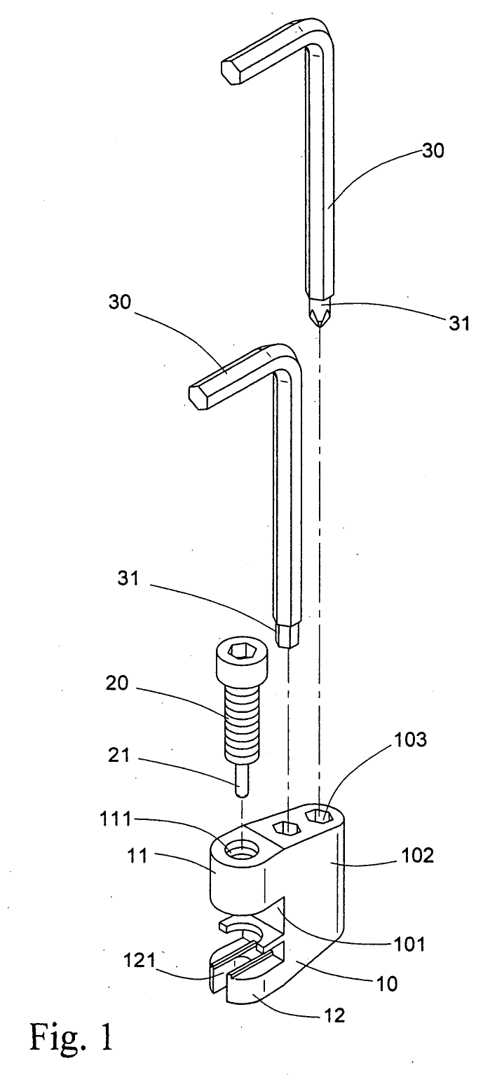

With reference to FIGS. 1 to 3, the chain detaching handle tool of the present invention is illustrated. The handle tool includes the following elements.

A body 10 is a metal block. A center of one side of the body 10 has a notch 101. A first protrusion 11 is formed at an upper portion of the body 10 and a second protrusion 12 is formed at a lower portion of the body 10. A center of the first protrusion 11 has a screw hole 111. A push element 20 with a post 21 is received in the screw hole 111. The second protrusion 12 has a slot 121.

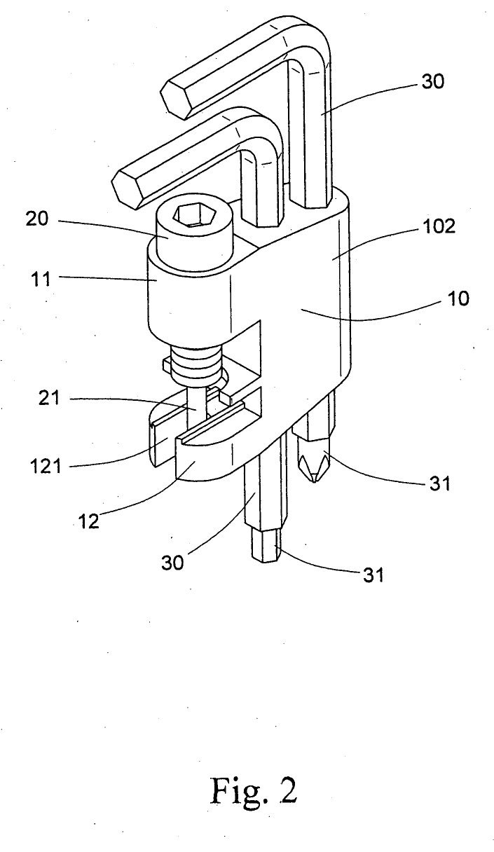

An extension portion 102 is at one side of the body 10 opposite to the notch 101. A plurality of penetrating holes 103 are formed in the extension portion 102. Each of the penetrating holes 103 is passed by a rod unit 30. Each rod unit 30 has an L shape. One side of each rod unit 30 has a driving portion 31 which may be a polygonal shape, a cruciform shape, a straight shape, etc., as shown in FIGS. 1 and 2.

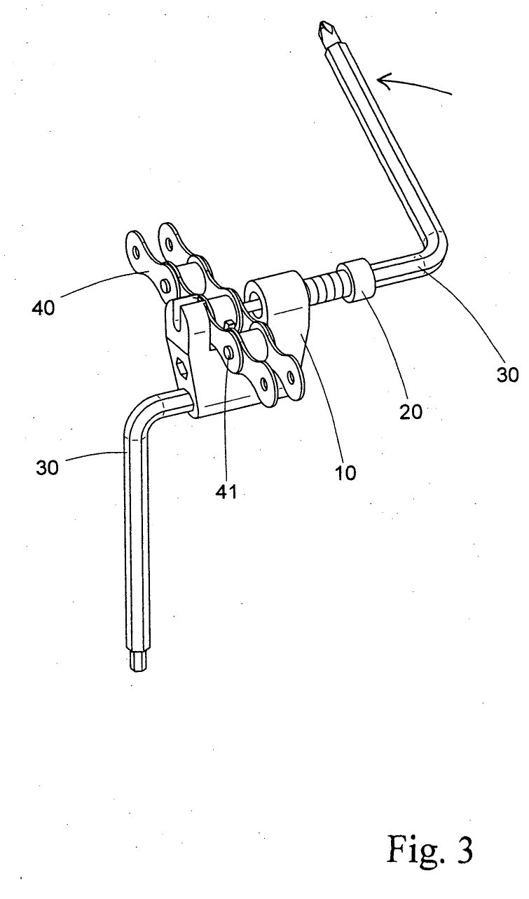

With reference to FIGS. 1 to 3, the operation of detach a chain according to the present invention is illustrated. A chain 40 is placed in the notch 101 of the body 10. Then the push element 20 is screwed so that the post 21 of the push element 20 resists against an end portion of the pin 41 of the chain 40. Furthermore, since the extension portion 102 of the body 10 of the handle tool of the present invention have a plurality of polygonal penetrating holes 103, each penetrating hole 103 is passed through by a rod unit 30. The user can take out the rod unit 30 from the penetrating hole 103 of the body 10. Then another end of the L shape bending portion of the rod unit 30 is inserted into the penetrating hole 103 again. The push element 20 is rotated by the L shape bending portion of another rod unit 30 (referring to FIG. 3). Thus, the chain can be detached. Thereby, the operation is easy and force-saved.

Besides, each rod unit 30 of the present invention is inserted into the penetrating hole 103 of the body 10 so as to prevent the rod unit 30 from rotation. Thereby, when the rod unit 30 is inserted into the body 10, it only occupied a minimum space. Thereby, since one side of each rod unit 30 has the driving portion 31 which may be a polygonal shape, a cruciform shape, a straight shape, etc., as shown in FIGS. 1 and 2, it can be used in any place for releasing or locking a screwing element.

Furthermore, the structure of the extension portion 102 of the body 10 is not only confined to above embodiment, other structure is allowable in the concept of the present invention.

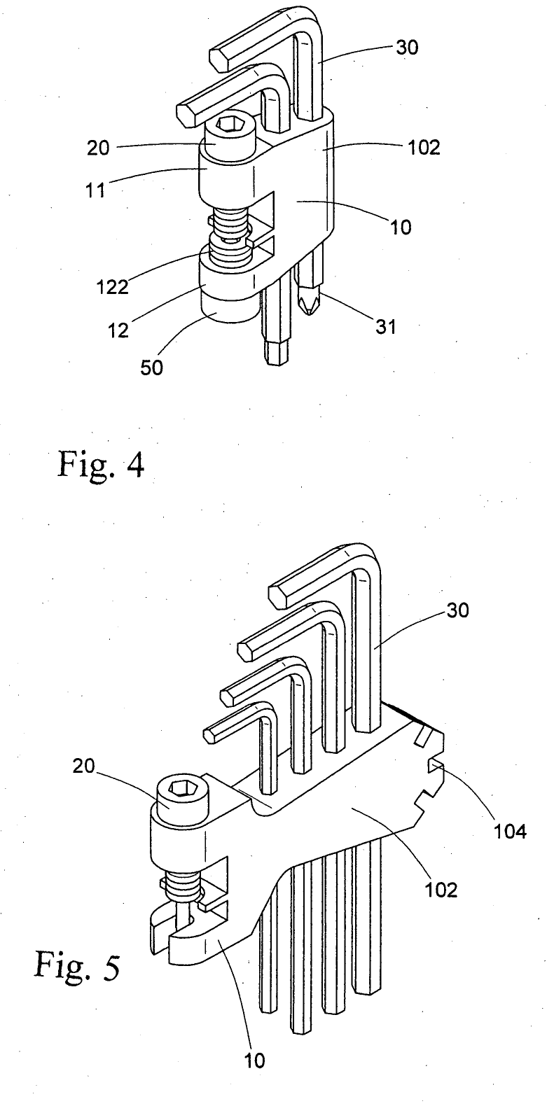

Referring to FIG. 4, the second protrusion 12 of the body 10 has a screw hole 122 instead of a slot 121. A resisting element 50 can be screwed into the screw hole 122 so as to achieve the object of detaching a chain.

With reference to FIG. 5, one end of the extension portion 102 of the body 10 can be installed with a notch 104 for being as a spanner for opening an object.

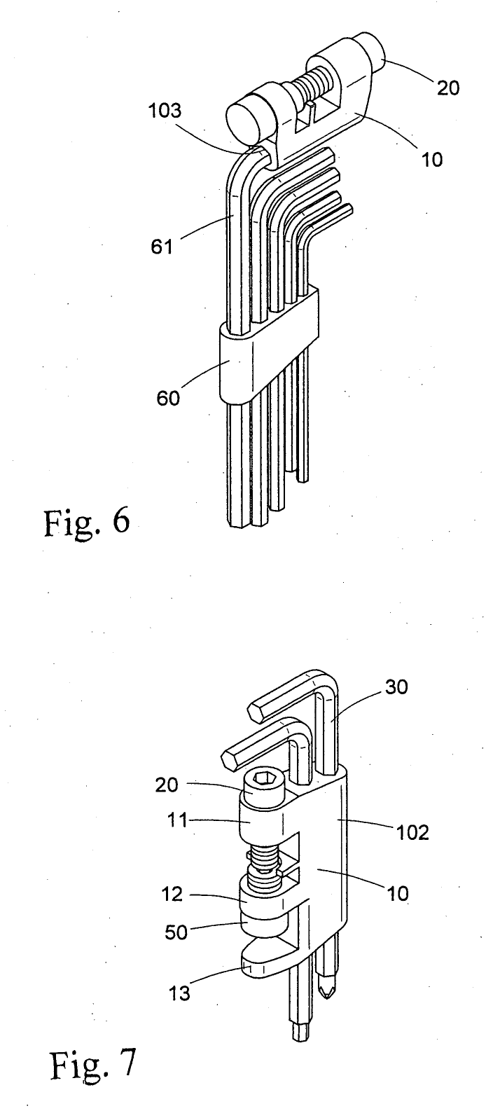

Referring to FIG. 6, it is illustrated that one section of a hexagonal spanner 61 of a spanner set 60 is inserted into the penetrating hole 103 of the extension portion 102 so that they are carried conveniently.

With reference to FIG. 7, a third protrusion 13 is protruded from the body 10 and below the second protrusion 1. The resisting element 50 is rotatable downward so as to be used as an adjustable spanner.

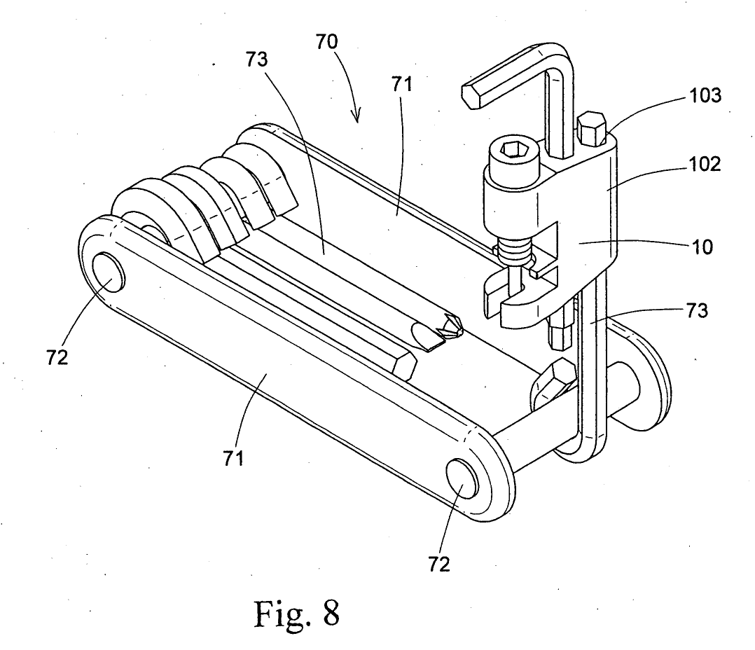

With reference to FIG. 8, a tool set 70 is assembled to the present invention. The tool set 70 has two sheets 71, at least one pivotal shaft 72 and a plurality of tools 73.

In the tool set, the two sheet bars 71 are installed oppositely. Two pivotal shafts 72 are installed at two sides of the two sheet bars 71. A plurality of tools 73 are installed to the pivotal shaft 72. The tools 73 are rotatable along the pivotal shaft 72.

The tool 73 can be assembled to the body 10. One selected tool is inserted into the penetrating hole 103 in the extension portion 102 of the body 10 so that the body 10 is foldable. The whole structure is simple and effective (referring to FIG. 7).

Moreover, in the present invention, the two sheets 71 can be formed integrally as a U shape body (not shown).

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A chain detaching handle tool comprising:
a body; a center of one side of the body having a notch; a first protrusion being formed at an upper portion of the body and a second protrusion being formed at a lower portion of the body; a center of the first protrusion having a screw hole; a push element with a post being received in the screw hole; and the second protrusion having a slot; and
an extension portion at one side of the body opposite to the notch; a plurality of penetrating holes being formed in the extension portion; each of the penetrating holes being passed by a rod unit; each rod unit having an L shape; and one side of each rod unit having a driving portion for driving an object.

2. The chain detaching handle tool as claimed in claim 1, wherein the driving portion of each rod unit has a polygonal shape.

3. The chain detaching handle tool as claimed in claim 1, wherein the driving portion of each rod unit has a cruciform shape.

4. The chain detaching handle tool as claimed in claim 1, wherein the driving portion of each rod unit has a straight shape.

5. The chain detaching handle tool as claimed in claim 1, wherein the second protrusion has a screw hole for installing a resisting element.

6. The chain detaching handle tool as claimed in claim 1, wherein the extension portion of the body has a plurality of slots.

7. The chain detaching handle tool as claimed in claim 5, wherein a third protrusion is protruded from the body and below the second protrusion; and the resisting element is rotated downward so as to be used as an adjustable spanner.

8. The chain detaching handle tool as claimed in claim 1, further comprising a tool set; the tool set comprising:
two sheets installed at opposite sides; two pivotal shafts being installed at two sides of the two sheets; a plurality of tools being installed to the pivotal shaft; the tools being rotatable along the pivotal shaft;
wherein the tools are capable of being assembled to the body; a selected one of the tools is inserted into the penetrating hole in the extension portion of the body.

9. The chain detaching handle tool as claimed in claim 8, wherein the two sheets are formed integrally as a U shape body.
